(19) United States
(12) Patent Application Publication
(10) Pub. No.: US 2019/0358601 A1
(43) Pub. Date: Nov. 28, 2019

(54) DEVICE AND USE OF THE DEVICE FOR PREHEATING AT LEAST ONE FLUID

(71) Applicant: BASF SE, Ludwigshafen am Rhein (DE)

(72) Inventors: Matthias KERN, Ludwigshafen am Rhein (DE); Grigorios KOLIOS, Ludwigshafen am Rhein (DE); Sabine SCHMIDT, Ludwigshafen am Rhein (DE); Heinrich LAIB, Ludwigshafen am Rhein (DE); Frederik SCHEIFF, Ludwigshafen am Rhein (DE); Bernd ZOELS, Ludwigshafen am Rhein (DE)

(21) Appl. No.: 16/332,017

(22) PCT Filed: Sep. 12, 2017
(86) PCT No.: PCT/EP2017/072887

§ 371 Date: Mar. 11, 2019

(30) Foreign Application Priority Data
Sep. 13, 2016 (EP) 16188612.2

(51) Int. Cl. B01J 6/00; F28F 7/02; F28F 21/04; C01B 3/24; C09C 1/54

(52) U.S. Cl. CPC B01J 6/008; F28F 7/02; F28D 2021/0022; C01B 3/24; C09C 1/54; F28F 21/04

(57) ABSTRACT

An apparatus (10) and the use thereof for preheating at least one fluid are proposed. The apparatus (10) has a solid heating body (12). Channels (16) for passage of the fluid are formed in the heating body (12). The heating body (12) is heatable. The heating body (12) is designed to heat the fluid to a target temperature within a target time, wherein the target temperature is at least a temperature at which a predetermined chemical reaction of the fluid takes place with a predetermined conversion within a predetermined time. The target time is shorter than the predetermined time. The heating body (12), for preheating of the fluid, is heated to the target temperature and the fluid is passed through the channels (16) within the target time.

The present invention relates to an improved apparatus and to a use thereof for preheating of at least one fluid.

The chemical conversion of volatile organic compounds in the gas phase frequently requires elevated temperatures. A problem here is the defined and mild transformation of the reactants from the storage temperature to the required reaction temperature in a preheating zone upstream of the reaction zone (preheating). The preheating is generally accomplished via convective heat transfer from the hot surface of a heat transferer to the fluid to be heated, “Defined” means that the fluid stream on exit from the preheating zone assumes a target temperature at which a predetermined conversion is achievable in the reaction zone within a predetermined dwell time. “Mild” means that the chemical conversion is suppressed.

As a result of their thermal instability, organic compounds have a tendency to thermal breakdown. As a consequence, solid deposits form on the heat transfer surfaces of the heat transferers, and these block the flow cross section and hence prevent heat transfer. For example, this is the case in the thermal cracking of hydrocarbons, in the dehydrogenation of ethylbenzene to styrene or of butane to butene, or in the cyclization of hydrocarbons containing one to three carbon atoms (C1 to C3 hydrocarbons).

As a result of the reactivity of organic compounds, especially in the presence of oxygen, they have a tendency to unselective reactions. As a consequence, the yield of the target products can be impaired. For example, this is the case in the autothermal dehydrogenation of C2 to C6 hydrocarbons, where the selective combustion of the hydrogen from the dehydrogenation is utilized for the supply of heat to the reaction. The reaction mixture here is to be preheated without significant conversion of the hydrocarbons prior to entry into a catalytically active reaction zone.

WO 2011/089209 A2 describes, for example, single-chamber evaporators and the use thereof in chemical synthesis.

In spite of the advantages achieved by these apparatuses or heat transferers, there is still potential for improvement. For instance, the single-chamber evaporator described in WO2011/089209 A2 has a complex construction, in which fine distribution of two fluid streams is required. The first fluid stream is the actual process stream and the second fluid stream is the heat carrier. The apparatus is designed as a micro- or milli-structured apparatus. Accordingly, the specific surface area of the heating area based on the process volume is 300 m²/m³ or greater. A disadvantage of this prior art is that the dense packing of the heat transferer tubes in a common tube plate is complex and prone to faults. This disadvantage correlates with the number and length of the sealing joints that hermetically separate the process stream and the heat source, i.e. the heat carrier, from one another. In the prior art, these are identical to the number and circumference of the heat transferer tubes.

It is therefore an object of the present invention to specify an apparatus and a use of the apparatus for preheating of at least one fluid, especially a gas comprising one or more thermally unstable compounds and/or two or more components that chemically react with one another, which at least substantially reduces the above-described disadvantages and more particularly extends the service life of the apparatuses.

According to the invention, the high specific surface area is necessary only between the reactive, or thermally unstable process fluid and the heat transferer wall. This is relevant for the efficiency of heat transfer. By contrast, the specific surface area between the heat transferer wall and the heat source, which brings about the preheating, can be much smaller. This area serves simultaneously as the sealing joint for the separation between the process stream and the heat source, i.e. the heat carrier, and defines the apparatus complexity of the apparatus.

A basic concept of the present invention is the great difference between the thermal conductivity of the process fluid, which is generally a gas, and the thermal conductivity of the heat transferer wall, which is generally manufactured from metal or ceramic. Consequently, a heat flow, given the same temperature differential, can be transmitted through considerably thicker layers of solids than in gases. According to the invention, the walls surrounding the process fluid are combined to form a coherent heating body.

An apparatus of the invention for preheating at least one fluid has a solid multichannel heating body. Moreover, the heating body is tubular. Channels for passage of the fluid are formed in the heating body. The heating body is heatable. The heating body is designed to heat the fluid to a target temperature within a target time. The target temperature is at least a temperature at which a predetermined chemical conversion of the fluid takes place with a predetermined conversion within a predetermined time. The target time is shorter than the predetermined time. This apparatus is used in accordance with the present invention for preheating of the at least one fluid. The heating body, for preheating of the fluid, is heated to the target temperature and the dwell time of the fluid in the heating body is not more than the target time.

The channels especially extend in a straight line in a direction of longitudinal extent. In this way, fluid-dynamic flow effects can be reduced, for example separation phenomena or eddy formation. Through the avoidance of curved channels, it is also possible to avoid deposits and dead zones in the fluid flow.

The channels are especially parallel to one another. In this way, homogeneous heat transfer to the respective channels is assured.

The channels may be cylindrical, especially circular cylindrical, or prismatic. This makes it clear that the shape of the cross section of the channels is only of minor significance for the technical effect of the apparatus of the invention.

In the context of the present invention, a solid heating body is understood to mean a body designed for heating of the fluid and having no cavities except for the channels. In other words, a cross section of the heating body comprises exclusively material of the heating body and no free space apart from the channels. The cross section of the heating body of the invention is the area enclosed by the boundary between the heating body and the heat source, projected in longitudinal direction of the channels. The cross section of the heating body may be regular or irregular, convex or concave. The heating body may advantageously be cylindrical, especially circular cylindrical, or prismatic. This makes it clear that the present invention is implementable with heating bodies of various configuration.

The heating body may have a longitudinal axis that runs parallel to the longitudinal axis of the channels. The channels may be distributed homogeneously over a cross section. In this way, particularly homogeneous heat transfer to the respective channels is assured. Alternatively, the channels may be distributed inhomogeneously over the cross section.

The heating body may have a structured outer shell, in which case the channels at least partly take the form of grooves in the outer shell. This mode of construction has advantages in manufacture, since grooves on the outline are easier to manufacture than bores in the cross section.

Multichannel tubes are known in industry. For example, multichannel tubes are used as filter cartridges for water treatment, for example under the PALL Schumasiv trade name.

In addition, ceramic multichannel tubes, for example consisting of cordierite, are used as heating element mounts for electrical heating cartridges, for example under the Rauschert PYROLIT cordierite trade name.

In addition, ceramic multichannel tubes, for example produced from α-Al₂O₃, are used as honeycomb heaters. For this purpose, an electrical conductor as resistance heater is embedded in the channel walls. Ceramic multichannel tubes of this kind are known to those skilled in the art and are described, for example, at http://www.keramverband.de/keramik/pdf/11/Sem11_14Keramik-Heizelemente.pdf.

In the context of the present invention, the target temperature is defined in terms of a predetermined chemical conversion of the fluid within a predetermined time. This definition is applicable since no exact temperature figure for a chemical conversion of fluids can be given. In other words, there is no temperature limit above which a reaction proceeds and below which the reaction does not take place, One possible reason is free radical formation, which at first proceeds without any measurable conversion of the reactants. As soon as a sufficient free-radical concentration has been attained, the reaction proceeds in a self-accelerated manner. For this reason, the target temperature figure is given after evaluation of the integral of the reaction rate over the dwell time in the preheating zone. Correspondingly, in the context of the present invention, it is assumed that a chemical conversion of the fluid does take place as a result of the temperature in the channels to a particular, albeit lesser, degree, but one that has no effect on the quality of the chemical conversion in a downstream reaction zone. For this reason, the fluid is guided through the channels within a target time shorter than the predetermined time in order to keep the conversion low, but to heat the fluid to a sufficiently high temperature for the downstream conversion. The temperature here on exit from the preheater may be lower than, equal to or higher than that in the downstream reaction zone.

The apparatus may also have a closed-loop control system for control of a temperature of the heating body. The target temperature may be a target temperature in the closed-loop control system. Correspondingly, the temperature of the heating body can be varied, especially automatically, by means of the closed-loop control system.

The heating body can be heated to a temperature of 100 to 1600° C., preferably of 400 to 1400° C. and more preferably of 700 to 1300° C. In the case of a corresponding design of the material of the heating body with regard to thermal conductivity, it is therefore possible to heat the fluid within the target time to a temperature close to the target value for the closed-loop temperature control system. It will be apparent that the thermal conductivity of the material of the heating body is defined at the aforementioned temperatures. By contrast, the thermal conductivity of the fluid is defined at 0° C.

The difference between the target temperature and the temperature at which the predetermined conversion takes place within the predetermined time may be from −200 K to +200 K, preferably −100 K to +100 K. In this way, the temperature of the fluid can be adjusted in respect of a desired conversion.

In accordance with the present invention, the predetermined time can be determined on the basis of the type of fluid and the target temperature. In other words, the predetermined time depends on the respective fluid and its composition.

The predetermined time can be determined on the basis of the type of fluid, especially by theoretical or empirical means. Correspondingly, the predetermined time is a known or ascertainable parameter. For example, the predetermined time can be ascertained using reference works known to those skilled in the art, for example lexicons or tables. Alternatively, the predetermined time can be ascertained by calculation, for example by simulation.

The target time may be 0.1 ms to 150 ms, preferably 0.5 ms to 75 ms, more preferably 1 ms to 50 ms, most preferably 2 ms to 25 ms. The target time is based correspondingly on the dwell time of the fluid in the channels. The dwell time is defined as the quotient of the length of the channels and the mean velocity of the fluid through the channels under standard conditions.

The figures given for the target time make it clear that the fluid is heated within a short time to a temperature that enables the main proportion of the desired mode of chemical conversion in an immediately downstream reaction zone, without any need for further heating to take place. The apparatus may especially be used continuously for preheating of the fluid. In this way, the overall chemical conversion of the fluid can be increased by means of the apparatus.

The pressure drop is an important process parameter which defines, for example, the strength-related design of the attached apparatuses or the power required for conveying of the process streams and additionally the operating costs of the process. In particular applications, the pressure drop permitted is determined by the vapor pressure of the process medium. Accordingly, it is advantageous, for example, to avoid a change in phase of the fluid to be heated in the apparatus. In addition, it is advantageous, for example, to meter the fluid into the preheater in liquid form and to conduct the evaporation in the preheater.

The permissible pressure drop can thus be fixed only in application-specific manner. Therefore, two ranges are specified. The first range comprises the absolute values specified below. A pressure differential of the fluid between an inlet and an outlet of the apparatus may be between 1 mbar and 900 mbar, preferably between 1 mbar and 500 mbar, more preferably between 1 mbar and 200 mbar, most preferably 1 mbar to 100 mbar. The second range comprises the relative values specified below, based on the pressure level of the process. A pressure differential of the fluid between an inlet and an outlet of the apparatus may be between 0.1% and 50%, preferably between 0.1% and 20%, more preferably between 0.1% and 10%, of an absolute pressure of the fluid at the inlet.

Finally, the dimensions of the heating body are determined by the required approximation of the fluid temperature to the defined target temperature. The relevant index for this purpose is the number of transfer units (NTU) achieved in the heating body. The determination of the NTU is known to those skilled in the art (chapter Ca in VDI-Wärmeatlas [VDI Heat Atlas], 9th edition, 2002). The NTU may be 0.1 to 100, preferably 0.2 to 50, more preferably 0.5 to 20, most preferably 2 to 5.

In the apparatus, a hydraulic diameter of the channels of the heating body is based on the target time. In other words, the apparatus and especially the hydraulic diameter of the channels is designed/selected as a function of the target time.

Advantageously, the hydraulic diameter of the channels is from 0.1 mm to 12 mm, preferably from 0.2 mm to 8 mm, more preferably from 0.3 mm to 4 mm, especially from 0.4 mm to 2 mm. With these values for the hydraulic diameter, the dwell time in the heating body for the use of the invention can be adjusted in a particularly efficient manner. Moreover, this avoids deposits on the walls of the channels that could otherwise block these.

Advantageously, the ratio of the hydraulic diameter of the heating body to the hydraulic diameter of a single channel is between 2 and 1000, preferably between 5 and 500, more preferably between 10 and 100. The hydraulic diameter is defined as the quotient of four times the cross section and the circumference of the body or the channel (chapter Ba in VDI-Wärmeatlas, 9th edition, 2002).

The number of channels based on the equivalent cross section of the heating body is from 2 to 1000, preferably from 5 to 500, more preferably from 10 to 100. The equivalent cross section of the heating body is defined here as the area of a circle having a diameter that corresponds to the hydraulic diameter of the heating body.

The total cross section of the flow channels (free cross section) is between 0.1% and 50%, preferably between 0.2% and 20%, more preferably between 0.5% and 10%, of the heating body cross section.

The length of the heating body is between 10 mm and 1000 mm, preferably from 30 mm to 300 mm.

The fluid can be guided through each of the channels 16 with a volume flow rate of 0.01 m³ (STP)/h to 500 m³ (STP)/h, preferably of 0.01 m³ (STP)/h to 200 m³ (STP)/h, more preferably of 0.01 m³ (STP)/h to 100 m³ (STP)/h and most preferably 0.01 m³ (STP)/h to 50 m³ (STP)/h.

The fluid may be a gas and especially a gas comprising thermally stable compounds and/or two or more components that chemically react with one another. Alternatively, the fluid may be a liquid and especially a liquid comprising thermally stable compounds and/or two or more components that chemically react with one another.

In the context of the present invention, a thermally unstable compound is understood to mean an organic chemical compound that, in a particular environment, above a particular temperature and within a particular time, achieves a particular chemical conversion to give solid reaction products (coke or polymers). The predetermined conversion may be caused by a reaction selected from the group consisting of: thermal breakdown (pyrolysis), dehydrogenation, chain polymerization, polycondensation.

In the context of this invention, components that chemically react with one another are understood to mean mixtures of organic compounds and oxygen which, in a particular environment, above a particular temperature and within a particular time, achieve a particular conversion to CO and/or CO₂. In the context of the present invention, this is understood, in a narrower sense, to mean hydrocarbon mixtures, for example natural gas, liquefied gas and naphtha, compounds comprising double bonds such as olefins, diolefins. The predetermined conversion may be caused by an oxidation reaction. The determining parameters of environment, temperature, time and conversion are dependent on the desired process conditions or the desired function. It is immaterial here whether the reaction is exothermic or endothermic.

The heating body may be heated around its circumference. The heat may be transferred here from a heat source by contact, by convection, by conduction of heat or by radiation of heat.

The heat source may be an electrical resistance heater, an exothermic chemical reaction, especially a combustion, or a superheated fluid heat carrier.

In addition, the heat can be generated directly at the circumference of the heating body, for example by electrical resistance heating or by a catalytic exothermic reaction.

The heating body can be heated across its volume. The heat can be generated here in an electrically conductive heating body via its ohmic resistance or via the introduction of eddy currents. Alternatively, the heating body may have heating elements embedded into its volume that are designed for the heating of the heating body. For example, these heating elements may be mineral-insulated jacket heat conductors or heating cartridges. The heat is distributed homogeneously across the volume of the heating body by virtue of the thermal conductivity of the solid material. As a result, a homogeneously high temperature is established at the walls of the capillaries in the block, which serves as the driving force for the introduction of heat into the fluid. The characteristic time constant that defines the heating of the gas can be ascertained by calculation.

The heating body may at least partly be formed from at least one metal and/or at least one ceramic. The metal may be at least one element selected from the group consisting of: ferritic steels, austenitic steels, nickel-base alloys, aluminum alloys, bronze, brass, copper, silver. The ceramic may be at least one element selected from the group consisting of: Al₂O₃ (corundum), SiC, carbon (graphite), AlN (aluminum nitride). Advantageously, the heating bodies have an open porosity of <0.3% according to DIN EN 623-2. Materials of this kind have good thermal conductivity.

Alternatively, the heating body may comprise materials of less good thermal conductivity, for example composed of amorphous SiO₂ (quartz glass) or of cordierite. Alternatively, the heating body may also have an open porosity according to DIN EN 623-2 of between 0.3% and 5%.

Multilayer structures are also conceivable in principle, for example a copper block with inset steel sleeves or a copper block that has been nickel-plated, silver-plated or gold-plated by electrolytic means. Alternatively, the heating body may also have been produced from two or more materials, for example a base body produced from copper with inset bushings of stainless steel into which heating elements have been embedded.

The heating body may be connected to a reaction section for performance of the predetermined reaction of the preheated fluid. The apparatus and the reaction section may be integrated, especially in a monolithic manner. The direct connection between the heating body that serves as preheater and the reaction section promotes a well-controlled dwell time in the process. If the preheater and the reaction section form a construction unit, for example have a common housing, the mechanical strength and reliability and especially the integrity of the apparatus is improved.

The reaction section may have a channel-shaped section, in which case the apparatus of the invention and the reaction section are formed such that the channels open into the channel-shaped section.

The channel-shaped section may have a cross-sectional area essentially identical to a cross-sectional area of the heating body. As a result, it is possible to achieve a homogeneous flow distribution along the entire process zone consisting of the preheating zone in the form of the heating body and the actual reaction zone in the form of the reaction section. For example, there are applications where a bundle of heating bodies feeds a common, especially adiabatic, reaction zone. The cross section of the reaction zone is greater than the cross section of the individual heating bodies. The heating bodies here may be installed in a common chamber, where they are supplied with heat.

The channel-shaped section may be hollow or may have been filled with a solid packing. The solid packing may be catalytically active or catalytically inert, and it may comprise the solid co-reactants (solid catalysts) for gas-solid reactions.

The predetermined conversion rate in the predetermined time can be determined in the reaction section.

A basic concept of the present invention is the axial division of a process zone into two zones, namely the preheating zone and the reaction zone, through which the process fluid flows successively. According to the invention, the preheating zone comprises a metallic or ceramic heating body with high heat capacity, which has continuous, straight channels having a cylindrical or prismatic cross section in longitudinal direction. The channels form the flow cross section for the fluid to be heated. The channels may be distributed homogeneously or inhomogeneously over the cross section of the heating body. Alternatively, the channels may be executed as grooves along the outer face of the block. The total cross section of the flow channels (free cross section) is between 0.1% and 50%, preferably between 0.2% and 20%, more preferably between 0.5% and 10%, of the heating body cross section. Consequently, the cross section of the heating body has a coherent solid matrix into which the channels are embedded.

The heating body may be heated around its circumference. The heat may be transferred here from a heat source by contact, by convection, by conduction of heat and/or by radiation of heat. The heat source may be an electrical resistance heater, an exothermic chemical reaction, especially a combustion, or a superheated fluid heat carrier.

In addition, the heat can be generated directly at the circumference of the heating body, for example by electrical resistance heating or by a catalytic exothermic reaction.

The heating body can be heated across its volume. The heat can be generated here in an electrically conductive heating body via its ohmic resistance or via the introduction of eddy currents. Alternatively, the heating body may have heating elements embedded into its volume that are designed for the heating of the heating body. For example, these heating elements may be mineral-insulated jacket heat conductors or heating cartridges.

The heat is distributed homogeneously across the volume of the heating body by virtue of the thermal conductivity of the solid material. As a result, a homogeneously high temperature is established at the walls of the capillaries in the block. The difference between the wall temperature and the fluid temperature serves as the driving force for the introduction of heat to the fluid. The characteristic time constant that defines the heating of the gas can be ascertained by calculation. The time constant for the heat transfer between heating body and fluid can be adjusted via the hydraulic diameter.

The heating body ends in a channel, the cross section of which corresponds roughly to the cross section of the heating body. This channel is the actual reaction zone in which the desired chemical conversion takes place. The cross section of the reaction zone may be empty or may have been filled with a solid packing. The void content of the process zone is typically in the range between 25% and 100%.

It has been found here that, surprisingly, in the preheating of thermally unstable compounds, the heating body fulfills its function without blockage of the channels by deposits formed from solid breakdown products of the fluid. Instead, according to the fluid, there is a certain tendency for the actual process zone to become blocked in the course of the process, even though it has a much greater free cross section than the heating body. However, because of its much greater free cross section, this is easier to clean than the capillary channels in the heating body.

It has been found that, surprisingly, in the preheating of fluids comprising components that chemically react with one another, the heating body fulfills its function without any significant conversion of unselective reactions taking place in the channels. Instead, the chemical conversion takes place almost exclusively in a catalytically controlled manner in the reaction zone. A positive side-effect of this behavior is that the ignition of exothermic reactions, for example oxidation reactions, in the feed channel is effectively suppressed. As a result, the preheater can also fulfill the function of a flame arrester.

In addition, it has been found that the apparatus of the invention is also suitable as a cooling zone for quenching of the product stream from a high-temperature reactor. This function is especially advantageous in the case of endothermic reactions, where the rapid cooling effectively suppresses the reverse reaction and the loss of yield caused thereby. Moreover, this function is advantageous in the case of thermally unstable products, where the rapid cooling effectively suppresses unwanted onward reactions and the loss of yield caused thereby.

The advantages of the invention can be summarized in the following points:
The manufacturing complexity for the preheating zone is considerably lower compared to a functionally equivalent solution in a milli- or microstructured design.
The heat transfer function and the barrier function are not rigidly coupled to one another. Depending on the process requirements, they can be combined with one another or decoupled from one another.
The heating body can be manufactured in a simple and inexpensive manner and allows a wide selection of materials. The material can also be selected according to the requirements on thermal stability, corrosion resistance and chemical passivity.
Compared to the heat transfer tubes packed with a solid bed that are comparable in terms of complexity, the solution of the invention differs in that virtually ideal plug flow can be achieved over the cross section of the preheater. As a result, the dwell time of the gas in the preheating zone can be set precisely. By virtue of the homogeneous, non-angled flow cross section of the channels, the formation of deposits and consequently the tendency of the heating body to become blocked are effectively suppressed.

In summary, the following possible embodiments of the invention are apparent:

### Embodiment 1

The use of an apparatus for preheating at least one fluid, wherein the apparatus has a solid heating body, wherein channels for passage of the fluid have been formed in the heating body, wherein the heating body is heatable, wherein the heating body is designed for heating of the fluid to a target temperature within a target time, wherein the target temperature is at least one temperature at which a predetermined chemical conversion of the fluid takes place with a predetermined conversion within a predetermined time, wherein the target time is less than the predetermined time, wherein the heating body, for preheating of the fluid, is heated to the target temperature and the fluid is guided through the channels within the target time.

### Embodiment 2

The use according to embodiment 1, wherein the predetermined time is determined on the basis of the nature of the fluid.

### Embodiment 3

The use according to embodiment 2, wherein the predetermined time is determined theoretically or empirically on the basis of the nature of the fluid.

### Embodiment 4

The use according to any of embodiments 1 to 3, wherein the apparatus further comprises a closed-loop control system for control of a temperature of the heating body, wherein the target temperature is a target value in the closed-loop control system.

### Embodiment 5

The use according to any of embodiments 1 to 4, wherein a hydraulic diameter of the channels of the heating body is based on the target time.

### Embodiment 6

The use according to any of embodiments 1 to 5, wherein the difference between the target temperature and the temperature at which the predetermined reaction of the fluid takes place with the predetermined conversion rate within the predetermined time is from −200 K to +200 K and preferably from −100 K to +100 K.

### Embodiment 7

The use according to any of embodiments 1 to 6, wherein the target time is 0.1 ms to 150 ms, preferably 0.5 ms to 75 ms, more preferably 1 ms to 50 ms, most preferably 2 ms to 25 ms.

### Embodiment 8

The use according to embodiment 7, wherein the target time is defined as the quotient of the length of the channels and the mean velocity of the fluid in the channels under standard conditions.

### Embodiment 9

The use according to any of embodiments 1 to 8, wherein the apparatus is used continuously for preheating of the fluid.

### Embodiment 10

The use according to any of embodiments 1 to 9, wherein a pressure differential of the fluid between an inlet and an outlet of the apparatus is between 1 mbar and 900 mbar, preferably between 1 mbar and 500 mbar, more preferably between 1 mbar and 200 mbar, most preferably between 1 mbar and 100 mbar.

### Embodiment 11

The use according to any of embodiments 1 to 9, wherein a pressure differential of the fluid between an inlet and an outlet of the apparatus is between 0.1% and 50%, preferably between 0.1% and 20%, more preferably between 0.1% and 10%, of an absolute pressure of the fluid at the inlet.

### Embodiment 12

The use according to any of embodiments 1 to 11, wherein the fluid is guided through each of the channels with a volume flow rate of 0.01 m³ (STP)/h to 500 m³ (STP)/h, preferably of 0.02 m³ (STP)/h to 200 m³ (STP)/h and more preferably of 0.05 m³ (STP)/h to 100 m³ (STP)/h, most preferably between 0.1 m³ (STP)/h and 50 m³ (STP)/h.

### Embodiment 13

The use according to any of embodiments 1 to 12, wherein the fluid is a gas and especially a gas comprising one or more thermally unstable compounds and/or two or more components that chemically react with one another.

### Embodiment 14

The use according to any of embodiments 1 to 13, wherein the predetermined reaction is a reaction selected from the group consisting of: thermal breakdown, dehydrogenation reaction, oxidation.

### Embodiment 15

The use according to any of embodiments 1 to 14, wherein the heating body is heated to a temperature of from 100° C. to 1600° C., preferably from 400° C. to 1400° C. and preferably from 700° C. to 1300° C.

### Embodiment 16

The use according to any of embodiments 1 to 15, wherein the heating body is heated directly or indirectly.

### Embodiment 17

The use according to any of embodiments 1 to 16, wherein the channels extend in a straight line in a direction of longitudinal extent.

### Embodiment 18

The use according to any of embodiments 1 to 17, wherein the channels are parallel to one another.

### Embodiment 19

The use according to any of embodiments 1 to 18, wherein the heating body is cylindrical, especially circular cylindrical or prismatic.

### Embodiment 20

The use according to embodiment 19, wherein the channels are parallel to a cylinder axis.

### Embodiment 21

The use according to any of embodiments 1 to 20, wherein the heating body has a longitudinal axis, wherein the channels are distributed homogeneously over a cross section of the heating body perpendicularly with respect to the longitudinal axis.

### Embodiment 22

The use according to any of embodiments 1 to 21, wherein the heating body has a structured outer shell, wherein the channels at least partly take the form of grooves in the outer shell.

### Embodiment 23

The use according to any of embodiments 1 to 22, wherein the sum total of the free cross sections of the channels based on the cross-sectional area of the heating body is from 0.1% to 50%, preferably from 0.2% to 20%, more preferably from 0.5% to 10%.

### Embodiment 24

The use according to any of embodiments 1 to 23, wherein the channels are cylindrical, especially circular cylindrical or prismatic.

### Embodiment 25

The use according to any of embodiments 1 to 24, wherein the heating body is formed at least partly from at least one metal and/or at least one ceramic.

### Embodiment 26

The use according to any of embodiments 1 to 25, wherein the channels have a diameter of 0.1 mm to 12.0 mm, preferably of 0.2 mm to 8 mm, more preferably between 0.3 mm and 4 mm, especially from 0.4 mm to 2 mm.

### Embodiment 27

The use according to any of embodiments 1 to 26, wherein the heating body is connected to a reaction section for performance of the predetermined reaction of the preheated fluid.

### Embodiment 28

The use according to embodiment 27, wherein the apparatus and the reaction section are integrated, especially in a monolithic manner.

### Embodiment 29

The use according to either of embodiments 27 and 28, wherein the reaction section has a channel section, wherein the apparatus and the reaction section are formed such that the channels open into the channel section.

### Embodiment 30

The use according to embodiment 29, wherein the channel section has a cross-sectional area essentially identical to a cross-sectional area of the heating body.

### Embodiment 31

The use according to embodiment 29 or 30, wherein the channel section is hollow or filled with a solid packing.

### Embodiment 32

The use according to any of embodiments 27 to 31, wherein the predetermined conversion rate in the predetermined time is determined in the reaction section.

### BRIEF DESCRIPTION OF THE DRAWINGS

Further optional details and features of the present invention will be apparent from the description of preferred working examples which follows, these being shown in schematic form in the drawings.

The figures show:

FIG. 1 a schematic diagram of the proportions of the phases by area in an apparatus of the invention,

FIG. 2 a collection of possible cross sections of the apparatus of the invention sorted according to geometric features,

FIG. 3 a rear view of an apparatus in a first embodiment of the present invention, FIG. 4 a cross-sectional view along the line A-A in FIG. 3,

FIG. 5 a rear view of an apparatus in a second embodiment of the present invention,

FIG. 6 a cross-sectional view along the line A-A in FIG. 5,

FIG. 7 a reactor with a thermostated reaction zone, wherein the cross section of the heating blocks is roughly equal to the cross section of the reaction zone, and

FIG. 8 a reactor with an adiabatic reaction zone, wherein the cross section of the heating blocks is significantly smaller than the cross section of the reaction zone.

### EMBODIMENTS OF THE INVENTION

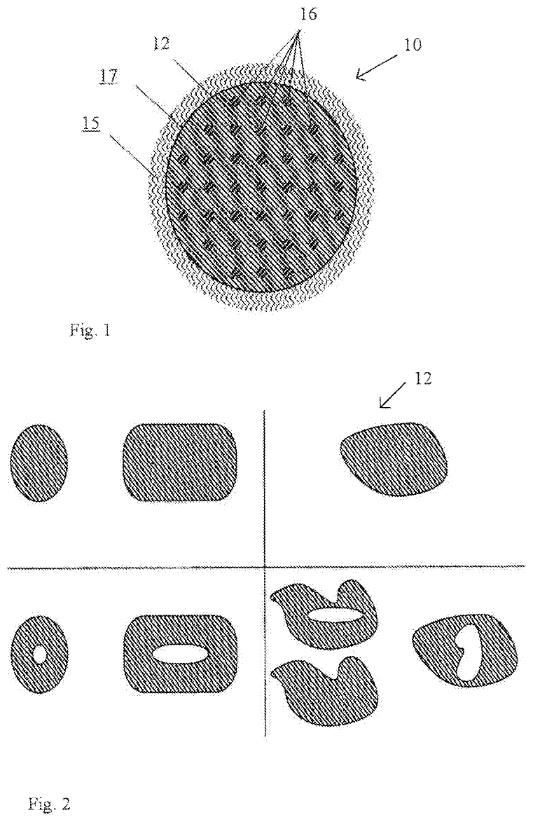

FIG. 1 shows a schematic diagram of the proportions of the phases by area in an inventive apparatus 10 for preheating of at least one fluid in a first embodiment of the present invention. The apparatus 10 has a solid heating body 12. The heating body 12 is at least partly formed from at least one metal and/or at least one ceramic. For example, the heating body 12 is manufactured from α-alumina (corundum). The heating body 12 is cylindrical, especially circular cylindrical. Correspondingly, the heating body 12 has a circular cross section. Alternatively, the heating body 12 may be prismatic or geometrically irregular, i.e. have a cross section of any shape, as described in more detail hereinafter. Correspondingly, the shape of the heating body 12 defines a longitudinal axis 14 along which the heating body 12 extends. In the example shown, the heating body 12 is fully surrounded by a heating chamber 15. Channels 16 are formed in the heating body 12. The channels 16 are designed for passage of a fluid to be heated. The channels 16 are designed, for example, as bores in the solid material of the heating body 12. The heating body 12 is heatable. The heating body 12 is especially directly or indirectly heatable. For example, the heating body itself may be designed as a heating element that electrically heats the fluid in the channels 16. In the example shown, the heating body 12 is fully surrounded by the heating chamber 15 and is separated therefrom by an impermeable joint 17. By means of conduction of heat, in operation, heat is transferred from the heating chamber 15 to the heating body 12 and thence to the channels 16 and the fluid present therein.

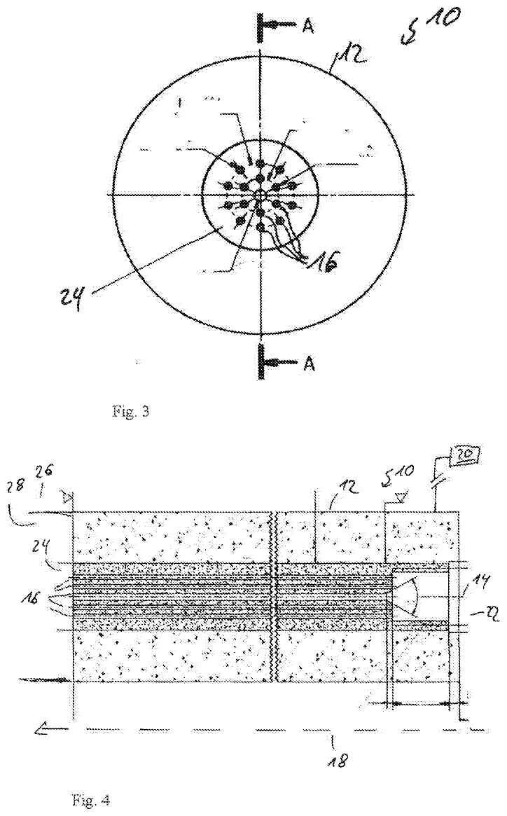

FIG. 2 shows a collection of possible cross sections of the inventive apparatus 10 sorted according to geometric features. FIG. 2 shows, on the left, possible cross sections with a regular shape and, on the right, possible cross sections with an irregular shape. The regular shapes shown are circular, rectangular with rounded edges, and star-shaped. In the case of the irregular shapes, all technically implementable shapes are possible, especially any desired shapes with roundings.

FIG. 3 shows a rear view of an apparatus in a first embodiment of the present invention. FIG. 4 shows a cross-sectional view along the line A-A in FIG. 3. The channels 16 extend in a straight line in a direction of longitudinal extent 18. The channels 16 here are parallel to one another. The channels 16 are parallel to the longitudinal axis 14. The channels 16, especially in the case of a cross section of the heating body 12 perpendicular to the longitudinal axis 14, are in irregular distribution. The channels 16 are cylindrical, especially circular cylindrical. Alternatively, the channels 16 may be prismatic. Alternatively, the heating body 12 may have a structured outer shell, in which case the channels 16 at least partly take the form of grooves in the outer shell.

Advantageously, the hydraulic diameter of the channels is from 0.1 mm to 12 mm, preferably from 0.2 mm to 8 mm, more preferably from 0.3 mm to 4 mm, especially from 0.4 mm to 2 mm. With these values for the hydraulic diameter, the dwell time in the heating body for the use of the invention can be adjusted in a particularly efficient manner. Moreover, this avoids deposits on the walls of the channels that could otherwise block these.

Advantageously, the ratio of the hydraulic diameter of the heating body to the hydraulic diameter of a channel is between 2 and 1000, preferably between 5 and 500, more preferably between 10 and 100. The hydraulic diameter is defined as the quotient of four times the cross section and the circumference of the body or the channel (chapter Ba in VDI-Wärmeatlas, 9th edition, 2002).

The number of channels based on the equivalent cross section of the heating body is from 2 to 1000, preferably from 5 to 500, more preferably from 10 to 100. The equivalent cross section of the heating body is defined here as the area of a circle having a diameter that corresponds to the hydraulic diameter of the heating body.

The total cross section of the flow channels (free cross section) is between 0.1% and 50%, preferably between 0.2% and 20%, more preferably between 0.5% and 10%, of the heating body cross section.

The length of the heating body is between 10 mm and 1000 mm, preferably from 30 mm to 300 mm. The fluid may be a gas and especially a gas mixture comprising one or more thermally unstable compounds and/or two or more components that chemically react with one another. The apparatus 10 may especially be used for continuous preheating of the fluid. The heating body 12 is especially designed to heat the fluid to a target temperature within a target time. The target temperature is at least a temperature at which a predetermined chemical conversion of the fluid takes place with a predetermined conversion within a predetermined time. The target time here is shorter than the predetermined time. The heating body 12, for preheating of the fluid, is then heated to the target temperature and the fluid is passed through the channels 16 within the target time. The predetermined time is determined on the basis of the nature of the fluid, as described in more detail hereinafter. For instance, the predetermined time can be determined theoretically or empirically on the basis of the nature of the fluid. For example, the predetermined time can be ascertained by simulation. Alternatively, there is standard software known to those skilled in the art, by means of which a conversion of the fluid can be determined (Kee, R. J., Miller, J. A., & Jefferson, T. H. (1980). CHEMKIN: A general-purpose, problem-independent, transportable, FORTRAN chemical kinetics code package. Sandia Labs).

The apparatus 10 may also have a closed-loop control system 20 for control of a temperature of the heating body 12. The target temperature here may be a target temperature in the closed-loop control system 20. A hydraulic diameter of the channels 16 of the heating body 12 is based here on the target time. The difference between the target temperature and the temperature at which the predetermined conversion of the fluid takes place within the predetermined time may be from −200 K to +200 K and preferably from −100 K to +100 K. The target time may be 0.1 ms to 150 ms, preferably 0.5 ms to 75 ms, more preferably 1 ms to 50 ms, most preferably 2 ms to 25 ms. The target time is based correspondingly on the dwell time of the fluid in the channels. The dwell time is defined as the quotient of the length of the channels and the mean velocity of the fluid through the channels under standard conditions. A pressure differential of the fluid between an inlet 22 and an outlet 24 of the apparatus 10 may be between 1 mbar and 900 mbar, preferably between 1 mbar and 500 mbar, more preferably between 1 mbar and 200 mbar and most preferably between 1 mbar and 100 mbar. A pressure differential of the fluid between the inlet 22 and the outlet 24 of the apparatus 10 may be between 0.1% and 50%, preferably between 0.1% and 20%, more preferably between 0.1% and 10%, of the absolute pressure of the fluid at the inlet 22. In general, the fluid can be guided through each of the channels 16 with a volume flow rate of 0.01 m³ (STP)/h to 500 m³ (STP)/h, preferably of 0.01 m³ (STP)/h to 200 m³ (STP)/h, more preferably of 0.01 m³ (STP)/h to 100 m³ (STP)/h and most preferably 0.01 m³ (STP)/h to 50 m³ (STP)/h. The predetermined conversion here may be a reaction selected from the group consisting of: thermal breakdown, dehydrogenation reaction, selectively heterogeneously catalyzed oxidation. The heating body 12 is heated to a temperature of 100 to 1600° C., preferably of 400 to 1400° C. and more preferably of 700 to 1300° C.

The heating body 12 may be connected to a reaction section 26 for performance of the predetermined conversion of the preheated fluid. The apparatus 10 and the reaction section 26 may be integrated, especially in a monolithic manner. The reaction section may have a channel section 28. The apparatus 10 and the reaction section 26 may be designed such that the channels 16 open into the channel section 28. The channel section 28 here may have a cross-sectional area essentially identical to a cross-sectional area of the heating body 12. The channel section 28 may be hollow. Alternatively, the channel section 28 may be filled with a solid packing. The predetermined conversion rate in the predetermined time is determined in the reaction section. Based on the diagram in FIG. 2, the fluid flows from right to left through the channels 16.

The design of the heating body 12 is based on the following relationship:

$${τ}_{hex} = \frac{NTU}{4 \cdot Nu \cdot a} \cdot {d}_{h}^{2}$$

The meanings of the symbols here are:

τₕₑₓ[s]: Dwell time of the fluid stream in the heating body 12. The dwell time is defined as the quotient of the volume of a channel 16 and the standard volume flow rate that flows through the channel 16.
NTU: Number of transfer units (NTU) which are to be implemented in the heating body 12. The determination of the NTU is known to those skilled in the art, for example from chapter Ca in VDI-Wärmeatlas, 9th edition, 2002.
Nu: The Nusselt number for heat transfer in a channel 16. Nu depends primarily on the flow regime. In the present case, in general, there is laminar flow in narrow capillary channels 16. In this case, Nu=3.66.

$$a [ \frac{{m}^{2}}{s} ] \text{:}$$

specific thermal conductivity of the fluid stream:

$$a = \frac{λ}{ρ \cdot {c}_{u}} .$$

a is a physical parameter.

$$ρ [ \frac{kg}{{m}^{3}} ] :$$

density of the fluid.

$${c}_{p} [ \frac{J}{kg \cdot K} ] :$$

specific heat capacity of the fluid at constant pressure.

$$λ [ \frac{W}{m \cdot s} ] :$$

coefficient of thermal conductivity of the fluid.
dₕ [m]: hydraulic diameter of a channel 16.

The length of the heating body 12 Lₕₑₓ can be determined with the aid of the following relationship:

$${L}_{hex} = {v}_{N} \cdot {τ}_{hex} = \frac{NTU}{4 \cdot Nu} \cdot \frac{{v}_{N}}{a} \cdot {d}_{h}^{2}$$

In this equation, v_{N} means the mean superficial velocity in a channel 16. v_{N} is defined as the quotient of the standard volume flow rate that flows through the channel 16 and the cross section of the channel 16. Lₕₑₓ and v_{N} are free parameters for the purposes of the primary object of the heating body 12. In reality, they are defined by secondary conditions. Such secondary conditions may be: installation length, pressure drop, flow rate. The correlation between Lₕₑₓ and the available installation length is obvious. The pressure drop is an important process parameter which defines, for example, the strength-related design of the apparatuses or the power required for conveying of the process streams. In particular applications, the pressure drop permitted is determined by the vapor pressure of the process medium. It is advantageous, for example, to avoid any change of phase in the heating body 12. The permissible pressure drop can thus be fixed only in an application-specific manner. Therefore, two ranges are specified. One comprises absolute values; the second comprises relative values based on the pressure level of the process. For a given pressure drop, the flow rate is calculated from the following relationship:

$${v}_{N} = \sqrt{\frac{8}{{λ}_{eff}} \cdot \frac{Nu}{Pr \cdot NTU} \cdot \frac{Δ p}{{ρ}_{N}} \cdot \frac{{T}_{N}}{{T}_{avg}} \cdot \frac{{p}_{N}}{{p}_{avg}}}$$

where:
Δp: pressure drop across the preheater.
λ_{eff}: pressure drop coefficient of the capillaries. Δ_{eff} is dependent on the flow regime. In the case of laminar flow: Δ_{eff}=64).
Pr: Prandtl number (substance value).
ρ_{N}: density under standard conditions (substance value at T=273 K, p=1.0135 bar).
T_{N}: temperature under standard conditions according to DIN 1945 (273 K).
T_{avg}: mean fluid temperature along the preheater.
p_{N}: absolute pressure under standard conditions according to DIN 1945 (1.0135 bar).
p_{avg}: mean pressure along the preheater.

For laminar flow in the capillaries:

$${v}_{N} = \sqrt{\frac{0.4575}{Pr \cdot NTU} \cdot \frac{Δ p}{{ρ}_{N}} \cdot \frac{{T}_{N}}{{T}_{avg}} \cdot \frac{{p}_{N}}{{p}_{avg}}}$$

There is an upper limit to the flow rate. For example, it should be lower than the speed of sound. Moreover, the backpressure of a jet on exit from a capillary should be restricted.

The power \dot{Q}_{cap} that the fluid stream absorbs in a channel 16 can be determined with the aid of the following relationship:

$${\dot{Q}}_{cap} = \frac{π}{4} \cdot {d}_{h}^{2} \cdot \frac{{v}_{N}}{{V}_{m ol}} \cdot {c}_{p , N} \cdot Δ {T}_{gas}$$

where:
Vₘₒₗ: molar volume under standard conditions

$$( 22.414 \frac{{m}^{3}}{k mol} ) .$$

c_{p,N}: mean molar heat capacity of the fluid.
ΔT_{gas}: the temperature differential by which the fluid stream is heated in the heating body 12

ΔT_{gas}=T_{target}−Tᵢₙ(approximately: T_{wall}−Tᵢₙ).

The total power that the heating body 12 has to expend is calculated as:

$${\dot{Q}}_{tot} = n \cdot {\dot{Q}}_{cap} = ɛ \cdot {( \frac{D}{{d}_{h}} )}^{2} \cdot {\dot{Q}}_{cap}$$

where:
ε: free cross section of the heating body 12 (total cross-sectional area of the channel 16 based on the cross section of the heating body 12).
D: diameter of a circle of equal area to the heating body 12.

The mean volume-based heat flow density in the heating body 12 is calculated as:

$${\dot{q}}_{V} = \frac{{\dot{Q}}_{tot}}{\frac{π}{4} \cdot {D}^{2} \cdot {L}_{hex}}$$

and after substitution:

$${\dot{q}}_{V} = \frac{4 \cdot ɛ \cdot Nu \cdot {λ}_{g}}{NTU \cdot {d}_{h}^{2}} \cdot Δ {T}_{gas}$$

If the heat is introduced entirely via the outer face of the heating body 12, the area-based heat flow density in the outer face is:

$${\dot{q}}_{A} = \frac{D}{4} \cdot {\dot{q}}_{V}$$

Using \dot{q}_{V} and \dot{q}_{A}, it is possible to obtain value ranges for the degrees of freedom ε and D. The volume flow rate is then calculated from the other parameters.

Possible value ranges for the aforementioned parameters are listed in table 1 below.

TABLE 1

| | | | | | | | |
|---|---|---|---|---|---|---|---|
| ll | llp | llpp | llvpp | ulvpp | ulpp | ulp | ul |

Adjustable parameters/degrees of freedom

| NTU [1] | 0.1 | 0.2 | 0.5 | 2 | 5 | 20 | 50 | 100 |
|---|---|---|---|---|---|---|---|---|
| ${\dot{V}}_{N} [ \frac{{m}^{3}}{h} ]$ | 0.01 | | | | 50 | 100 | 200 | 500 |
| dₕ [mm] | 0.1 | 0.2 | 0.3 | 0.4 | 2 | 4 | 8 | 12 |

| ε [1] | 0.001 | 0.002 | 0.005 | 0.1 | 0.2 | 0.5 |
|---|---|---|---|---|---|---|
| Lₕₑₓ [m] | 0.01 | | | 0.1 | 1 | 10 |
| D [mm] | 5 | 10 | 20 | 100 | 200 | 300 |

Target numbers for operating parameters

| | | | | | | | | |
|---|---|---|---|---|---|---|---|---|
| ${v}_{N} [ \frac{m}{s} ]$ | 1 | 2 | 5 | 10 | 100 | 150 | 200 | 300 |
| τₕₑₓ [ms] | 0.1 | 0.5 | 1 | 2 | 25 | 50 | 75 | 150 |

| $\frac{Δ p}{{p}_{avg}} [ 1 ]$ | 0.1% | 10% | | 20% | 50% |
|---|---|---|---|---|---|
| Δp [mbar] | 1 | 100 | 200 | 500 | 900 |

| | | |
|---|---|---|
| ${\dot{q}}_{V} [ \frac{MW}{{m}^{3}} ]$ | 0.01 | 15 |
| ${\dot{q}}_{A} [ \frac{kW}{{m}^{2}} ]$ | 0.1 | 500 |

Parameters in table 1 mean:

{u/l}l: upper/lower limit,
{u/l}lp: upper/lower limit preferred,
{u/l}lpp: upper/lower limit particularly preferred, and
{u/l}lvpp: upper/lower limit very particularly preferred.

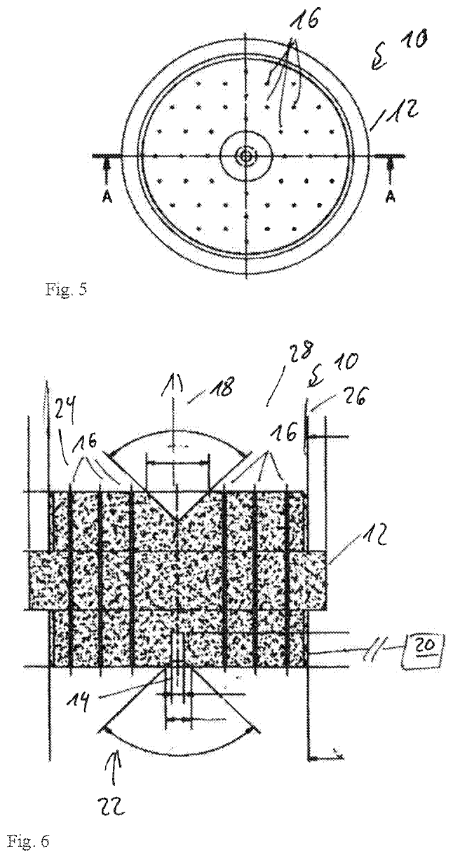

FIG. 5 shows a rear view of an apparatus 10 for preheating of a fluid in a second embodiment of the present invention. FIG. 6 shows a cross-sectional view along the line A-A in FIG. 4. Only the differences from the previous embodiment are described hereinafter, and identical components are given the same reference numerals. In the apparatus 10 of the second embodiment, the heating body 12, by comparison with the heating body 12 from the first embodiment, has a shorter length in the direction 18 of longitudinal extent. In addition, the channels 16 are in denser distribution over the cross section of the heating body 12, meaning that they extend to close to an outer circumferential face of the heating body 12. Based on the diagram in FIG. 6, the fluid flows from the top downward through the channels 16.

It is emphasized explicitly that the apparatus described herein is not restricted to above-described embodiments or configurations. The above-described embodiments are merely a selection of possible constructions of the apparatus 10. The inventive apparatus 10 and the use thereof are to be illustrated by the examples which follow. It is emphasized explicitly that the apparatus 10 described herein is not restricted to the preheating of the working examples described below. The working examples elucidated hereinafter are merely a selection of possible fluids that can be preheated with the inventive apparatus 10.

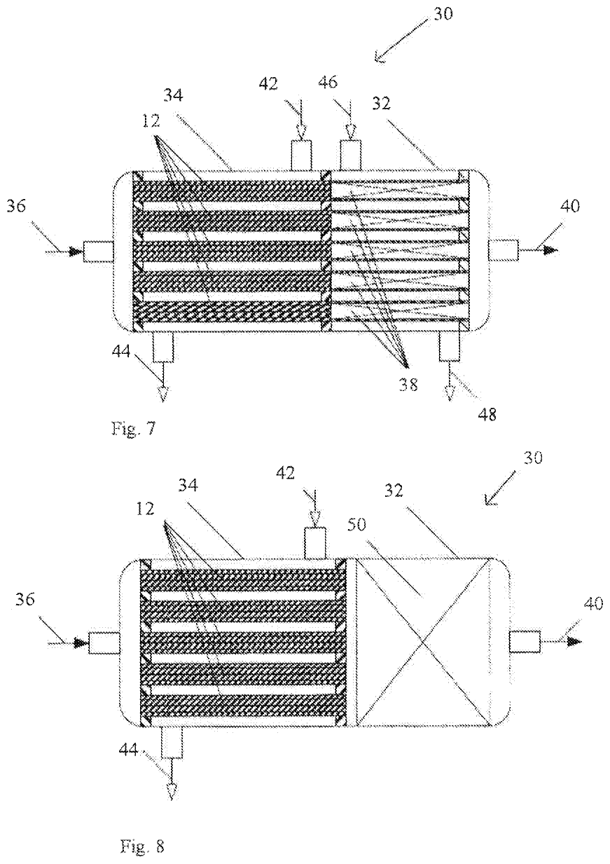

FIG. 7 a reactor 30 with a thermostated reaction zone 32, wherein the cross section of the heating bodies 12 is roughly equal to the cross section of the reaction zone 32. What is shown is the arrangement of multiple heating bodies 12 in a preheating zone 34 of the reactor 30 and the adjoining reactor zone 32. The heating bodies 12 have been inserted into heat transferer tubes. The fluid to be heated passes via a feed 36 into the preheating zone 34, and thence into the heating bodies 12, in order to be preheated, then into the reaction zone 32, where the actual conversion of the fluid takes place in reaction tubes 38 with solid packing, and it leaves the reactor 30 via an outlet 40. For preheating of the fluid, the preheating zone 34 has a feed 42 for a heating medium and an outlet 44 for the heating medium. Analogously, the reaction zone 32 has a feed 46 for a heating medium and an outlet 48 for the heating medium.

FIG. 8 shows a reactor 30 with an adiabatic reaction zone 32, wherein the cross section of the heating bodies 12 is significantly smaller than the cross section of the reaction zone 32. The difference from the reactor of FIG. 7 can be seen in the reaction zone 32 which, rather than multiple reaction tubes 38, has a solid packing 50, such that the feed 46 and the outlet 48 are also dispensed with.

### Example 1

Example 1 is described with reference to the first embodiment of the apparatus 10 in FIGS. 4 and 5. The fluid is methane. The predetermined time is ascertained depending on the nature of the fluid. This fluid is to be subjected to a conversion to hydrogen and pyrolysis carbon. The conversion takes place at a predetermined temperature of 1200° C. A predetermined relative conversion of 73.59% within a predetermined period of 1.2 s can be ascertained using measurements in the reaction section 26 in a thermostated flow reactor.

The relative conversion of methane is defined as follows:

$${X}_{CH 4} = 1 - \frac{{\dot{N}}_{CH 4}^{prod}}{{\dot{N}}_{CH 4}^{feed}}$$

where:
\dot{N}_{CH4}^{prod}: molar flow rate of methane at the outlet of the reaction zone.
\dot{N}_{CH4}^{feed}: molar flow rate of methane in the feed to the reaction zone.

In the specific case, the relative conversion can be determined purely from concentration measurements:

$${X}_{CH 4} = 1 - \frac{{y}_{CH 4}^{prod}}{( 1 + {y}_{CH 4}^{prod} + {y}_{C 2 H 4}^{prod} + {y}_{C 6 H 6}^{prod} ) \cdot {y}_{CH 4}^{feed}}$$

where:
yⱼ^{prod},j=CH4, C2H4, C6H6: the mole fractions of the methane, ethylene, benzene components at the exit from the reaction zone.
y_{CH4}^{feed}: the mole fraction of methane in the feed to the reaction zone.

The mole fractions of the components specified are measured with the aid of a Fourier transformation infrared spectrometer (FTIR).

The predetermined time for the performance of the reaction is defined as follows:

$${τ}_{rx} = \frac{{ɛ}_{rx} \cdot π / 4 \cdot {D}_{rx}^{2} \cdot {L}_{rx}}{{\dot{V}}_{N}^{feed} \cdot \frac{{T}_{rx}}{{T}_{N}} \cdot \frac{{p}^{feed}}{{p}_{N}}}$$

where:
εᵣₓ: void content of the solid packing in the reaction zone. A suitable measurement method is described in the following publication: Ridgway, K., and K. J. Tarbuck. “Radial voidage variation in randomly-packed beds of spheres of different sizes.” Journal of Pharmacy and Pharmacology 18.S1 (1966): 168S-175S.
Dᵣₓ,Lᵣₓ: diameter and length of the reaction zone.
\dot{V}_{N}^{feed}: standard volume flow rate in the feed to the flow reactor. A suitable measurement method is thermal mass flow meters.
Tᵣₓ: the predetermined temperature in the reaction zone.
T_{N}: the temperature under standard conditions according to DIN 1945 (273.15 K).
p^{feed}: the absolute pressure in the feed to the reaction zone.
p_{N}: the absolute pressure under standard conditions according to DIN 1945 (1.0135 bar).

At the predetermined methane conversion, the following product yields are achieved:

| Carbon-containing | |
|---|---|
| product | Yield |
| pyrolysis carbon | 61.2% |
| C₂H₂ | 4.2% |
| C₂H₄ | 4.0% |
| C₆H₆ | 4.1% |
| Sum total | 73.5% |

Pyrolysis carbon is the target product and the hydrocarbons C₂H₂, C₂H₄ and C₆H₆ are intermediates in the pyrolysis.

Therefore, for the preheating, a target temperature of 1200° C. based on the desired reaction temperature or predetermined temperature is ascertained. The permissible relative preliminary conversion allowed to take place in the heating body 12, measured at the exit 24 from the heating body 12, should be less than 5%. The value for the preliminary conversion is freely defined. The aim of the specification is that no significant conversion takes place at the end of the preheating zone, i.e. at the exit 24 from heating body 12. Based on experience, a sensible threshold value is fixed at a conversion of 5%. This value is guided by the accuracy of the carbon balance in the analysis of the gas phase composition. The fluid should be heated to this target temperature within a target time of less than 50 ms. The value for the target time is ascertained by the simulation of the homogeneous breakdown of methane in an ideal tubular reactor at 1200° C. with the aid of the GRI-3.0 mechanism (http://www.me.berkeley.edu/gri_mech/). The value specified corresponds to a dwell time at which the methane conversion is much less than 5%. “Much less” means here that the value reported corresponds to about ⅕ of the time interval in which 5% conversion is theoretically achieved. The deviation from the target value should be less than 10 K. Within this target time, the fluid thus has to be guided through the channels 16 of the heating body 12. In this working example, the heating body 12 has a number of 16 channels 16. The number of channels 16 is determined by target parameters including those which follow.

The length of the heating body 12 is fixed at 200 mm by construction specifications of a first test zone. The maximum throughput is 1 m³ (STP)/h. The following design specifications are to be achieved: NTU not less than 5, pressure drop in the heating body 12 less than 10 mbar, corresponding to about 1% of the absolute pressure of the fluid of 1.15 bar at the exit 22 from the heating body 12, dwell time less than 10 ms.

The heating body 12 has a cross-sectional area of 18 cm². Based on the target time, a hydraulic diameter of each channel 16 of 1.2 mm is ascertained. The fluid is guided through each channel 16 at a volume flow rate of 92.6 L (STP)/h. This gives rise to a mean velocity (theoretical value under standard conditions) of 22.75 m/s.

### Example 2

Example 2 is described with reference to the second embodiment of the apparatus 10 in FIGS. 6 and 7. The fluid is methane. The predetermined time is determined depending on the nature of the fluid. This fluid is to be subjected to a conversion to hydrogen and pyrolysis carbon. Proceeding from example 1, there is a need in example 2 to achieve a higher reaction speed for the pyrolysis reaction, in order to increase the yield of pyrolysis carbon and to eliminate the intermediates. For this purpose, advantageously, the reaction temperature is raised and the dwell time in the reaction section 26 is extended. The conversion usually takes place at a predetermined temperature of 1400° C. A predetermined relative conversion higher than 99.5% within a predetermined period of 2.4 s can be ascertained using measurements in the reaction section 26.

At the predetermined methane conversion, the following product yields are achieved:

| Carbon-containing | |
|---|---|
| product | Yield |
| pyrolysis carbon | 99.5% |
| C₂H₂ | 0% |
| C₂H₄ | 0% |
| C₆H₆ | 0% |
| Sum total | 99.5% |

Therefore, a target temperature of 1400° C. based on the desired reaction temperature or predetermined temperature is ascertained. The fluid should be heated to this target temperature within a target time of less than 2 ms. The deviation from the target value should be less than 10 K. Within this target time, the fluid thus has to be guided through the channels 16 of the heating body 12. In this working example, the heating body 12 has a number of 44 channels 16. The number of channels 16 is determined by target parameters including those which follow. The length of the heating body 12 is fixed at 35 mm by construction specifications of a second test zone. The channels 16 are distributed homogeneously over the cross section of the heating body 12. The maximum throughput is 0.5 m³ (STP)/h. The following design specifications are to be achieved: NTU not less than 5, pressure drop in the heating body 12 less than 10 mbar, which corresponds to about 1% of the absolute pressure of the fluid of 1.15 bar at the exit 22 from the heating body 12, dwell time less than 1 ms.

The heating body 12 has a cross-sectional area of 18 cm². Based on the target time, a hydraulic diameter of 0.5 mm is ascertained. For process-related reasons, the fluid is guided through each channel 16 at a volume flow rate of 11.5 L (STP)/h. This gives rise to a mean velocity (theoretical value under standard conditions) of 16 m/s. In order to heat the fluid to the target temperature within the target time with these parameters, the heating body 12 is heated under closed-loop control to a temperature of 1400° C.

In each of the examples 1 and 2 described above, the channels were examined for deposits or blockages after eight hours of operation of the apparatus 10. No significant deposits were found that would adversely affect the operation of the apparatus 10. This makes it clear that, with the inventive apparatus 10 and the use thereof, fluids, especially thermally sensitive organic compounds, can be preheated within a much shorter time compared to conventional apparatuses and, at the same time, the service life can be prolonged compared to conventional apparatuses.

### LIST OF REFERENCE SIGNS

10 apparatus
12 heating body
14 longitudinal axis
16 channels
18 direction of longitudinal extent
20 closed-loop control system
22 inlet
24 outlet
26 reaction section
28 channel section
30 flange

1.-17. (canceled)

18. A process comprising preheating at least one fluid in an apparatus, wherein the apparatus has a solid heating body, wherein channels for passage of the fluid have been formed in the heating body, wherein the heating body is heatable, wherein the heating body is designed for heating of the fluid to a target temperature within a target time, wherein the target temperature is at least one temperature at which a predetermined chemical conversion of the fluid takes place with a predetermined conversion within a predetermined time, wherein the target time is less than the predetermined time, wherein the heating body, for preheating of the fluid, is heated to the target temperature and the fluid is guided through the channels within the target time, wherein the heating body is connected to a reaction section for performance of the predetermined conversion of the preheated fluid.

19. The process according to claim 18, wherein the difference between the target temperature and the temperature at which the predetermined reaction of the fluid takes place with the predetermined conversion rate within the predetermined time is from −200 K to +200 K.

20. The process according to claim 18, wherein the target time is 0.1 ms to 150 ms.

21. The process according to claim 18, wherein the fluid is guided through each of the channels (16) with a volume flow rate of 0.01 m³ (STP)/h to 500 m³ (STP)/h.

22. The process according to claim 18, wherein the fluid is a gas.

23. The process according to claim 18, wherein the predetermined reaction is a reaction selected from the group consisting of: thermal breakdown, dehydrogenation, and oxidation.

24. The process according to claim 18, wherein the heating body is heated to a temperature of 100° C. to 1600° C.

25. The process according to claim 18, wherein the heating body is heated directly or indirectly.

26. The process according to claim 18, wherein the channels extend in a straight line in a direction of longitudinal extent.

27. The process according to claim 18, wherein the channels are parallel to one another.

28. The process according to claim 18, wherein the heating body is cylindrical.

29. The process according to claim 28, wherein the channels are parallel to a cylinder axis.

30. The process according to claim 18, wherein the heating body has a longitudinal axis, wherein the channels are distributed homogeneously over a cross section of the heating body perpendicularly with respect to the longitudinal axis.

31. The process according to claim 18, wherein the sum total of the free cross sections of the flow channels based on the cross-sectional area of the heating body is from 0.1% to 50%.

32. The process according to claim 18, wherein the channels are cylindrical.

33. The process according to claim 18, wherein the channels have a diameter of 0.1 mm to 12.0 mm.

34. The process according to claim 18, wherein the heating body is connected to the reaction section for performance of the predetermined reaction of the preheated fluid, wherein the apparatus and the reaction section are integrated.

35. The process according to claim 18, wherein the target time is 0.5 ms to 75 ms.

36. The process according to claim 18, wherein the target time is 1 ms to 50 ms.

37. The process according to claim 18, wherein the target time is 2 ms to 25 ms.
